(19) United States
(12) Patent Application Publication
(10) Pub. No.: US 2010/0102175 A1
(43) Pub. Date: Apr. 29, 2010

(54) CABLE SUPPORT

(76) Inventors: Forrest Allen Dockery, Simi Valley, CA (US); Bing Liu, Moreno Valley, CA (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/260,441

(22) Filed: Oct. 29, 2008

(51) Int. Cl. F16L 3/12

(52) U.S. Cl. 248/74.3; 248/62

(57) ABSTRACT

A support for supporting a run of cable, wire or conduit may include a semi-circular saddle, a stem portion, a closing tab and a catch. The saddle may have a front face and a rear face and it operate receive and support a plurality of cables. The stem may be formed integrally with, and extending tangentally from, one end of the saddle with the catch being supported on the stem opposite the closing tab. The closing tab may extend from an opposite end of the saddle and may be tapered along its length. Moreover, the width of the closing tab may be smaller than a width of the saddle at the point where the closing tab is integrated with the saddle. The tab is movable between a first orientation in which the saddle is open and a second orientation in which the closing tab engages the catch.

### FIELD OF THE INVENTION

Disclosed herein is a support or bracket that may have specific use in connection with supporting a run of cable, wire or conduit. However, the support may also be a multi-purpose support that may function to suspend or support a wide range of goods

### BACKGROUND OF THE INVENTION

Cable supports systems and assemblies have experienced a slow but steady advance of the art. For example, U.S. Pat. No. 2,466,912 was directed to a wire or conduit clip that consisted of a spring steel strap formed into an open loop. The loop could be closed using a tongue-like hook that engaged slots at the end of the strap. The clip could also be secured to a structure (i.e., a wall) using a fastener and nut.

The curved bracket disclosed by U.S. Pat. No. 4,039,131 was an integral member, normally made of steel, that could be plastic coated. The bracket included an arcuate part that had a relatively wide wall that was contoured as a upwardly concaved cylindrical segment. Parallel flanges also projected downwardly at right angles from either side of the wall.

The support of U.S. Pat. No. 5,740,994 included a saddle that had a smooth center circular surface. The saddle featured flanges that extended away from the center at each edge at an angle of about 45 degrees.

Finally, U.S. Pat. No. 6,945,501 showed a cable support that included a saddle that was formed from flat stock and featured an integral sleeve. The sleeve encased a portion of a support loop, and the flat stock of the saddle was able to flex so as to open and close the loop.

### SUMMARY OF THE INVENTION

The disclosed cable support may include a semi-circular saddle, a stem portion, a closing tab and a catch. The saddle may operate to retain and support a plurality of cables, wires or the like, with the stem and closing tab being formed integral with, and extending from, respective ends of the saddle.

The closing tab may be tapered along its length, with the width of the tab where it joins the saddle being smaller than the width of the saddle. This arrangement of the width of the tap may aid making the tap easier to manipulate. More specifically, the closing tab may be movable between a first orientation in which the tab extends tangentially from the end of the saddle and the saddle is open so that it may receive one or more cables, and a second orientation in which the tab engages the catch to form a rigid closure against cables escaping the saddle. The tab may also be positioned at an intermediate point between the first and second orientations.

The stem may include a recessed portion defined in its front face. Moreover, a mounting aperture that is dimensioned to receive fasteners, brackets and the like may be defined though the recessed portion for use in mounting the support to a wall, batwing bracket or similar apparatus.

A plastic cover or sleeve may be injection molded or otherwise formed or positioned around the support. The cover may, for example, overlay the support by extending over the front face of the saddle and the closing tab and over at least a portion of the stem. The cover may also extend around each edge of the support to overlay each side of the rear face and define a finger channel for use in holding the support during installation. Each edge of the cover may be angled. For example, each edge of the cover that overlays the front face of the saddle may extend downward, forming an obtuse angle. Likewise, each edge of the cover that overlays the rear face may extend upward, forming an obtuse angle relative to the portion of the cover that overlays the rear face of the support.

The catch may be a hook that is molded or otherwise formed integral with the cover. Alternatively, the catch may comprise of a pair of vertically spaced detents formed in the stem.

Finally, the support may include a pair of stiffing ribs that extend from the stem around the saddle. Parallel flanges may also be provided that project downwardly at right angles from either side of the front face.

### BRIEF DESCRIPTION OF THE DRAWINGS

Referring now to the associated figures, wherein like reference numerals refer to like parts throughout, and wherein:

FIG. 1 is a perspective side view of an embodiment of the disclosed cable support;

FIG. 2 is a planar front view of the cable support shown in FIG. 1;

FIG. 3 is a planar side view of the cable support shown in FIG. 1;

FIG. 4 is a planar top view of the cable support shown in FIG. 1;

FIG. 5 is a planar bottom view of the cable support shown in FIG. 1;

FIG. 6 is a planar rear view of the cable support shown in FIG. 1;

FIG. 7 is a perspective side view of another embodiment of the disclosed cable support;

FIG. 8 is a planar front view of the cable support shown in FIG. 7;

FIG. 9 is a planar side view of the cable support shown in FIG. 7;

FIG. 10 is a planar top view of the cable support shown in FIG. 7;

FIG. 11 is a planar bottom view of the cable support shown in FIG. 7; and

FIG. 126 is a planar rear view of the cable support shown in FIG. 7;

### DETAILED DESCRIPTION OF THE PREFERRED EMBODIMENTS

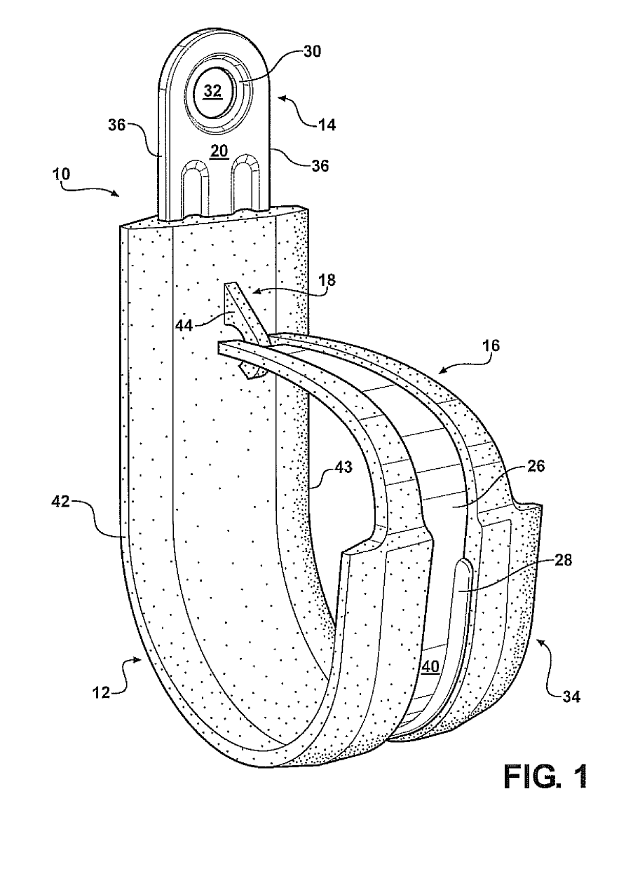

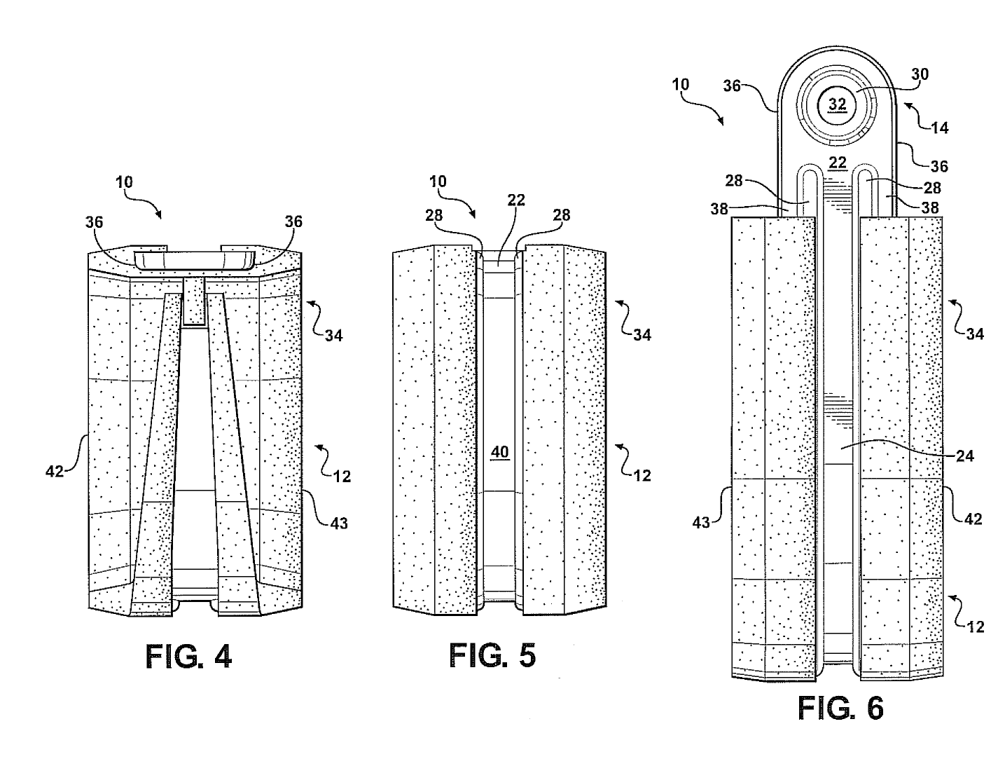

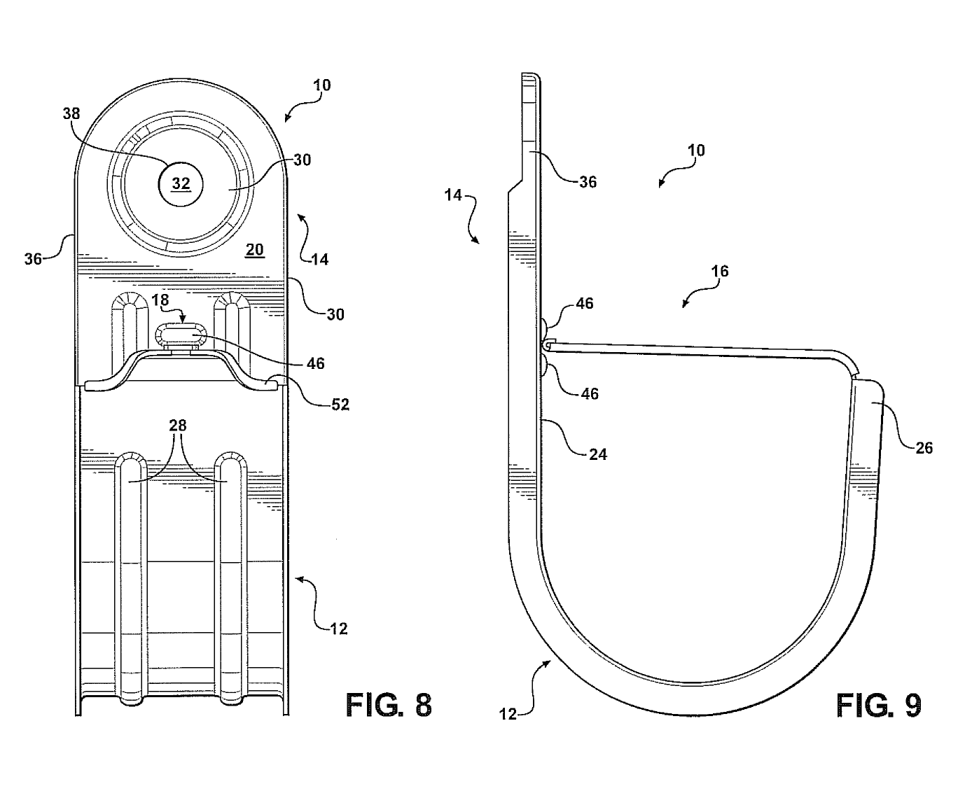

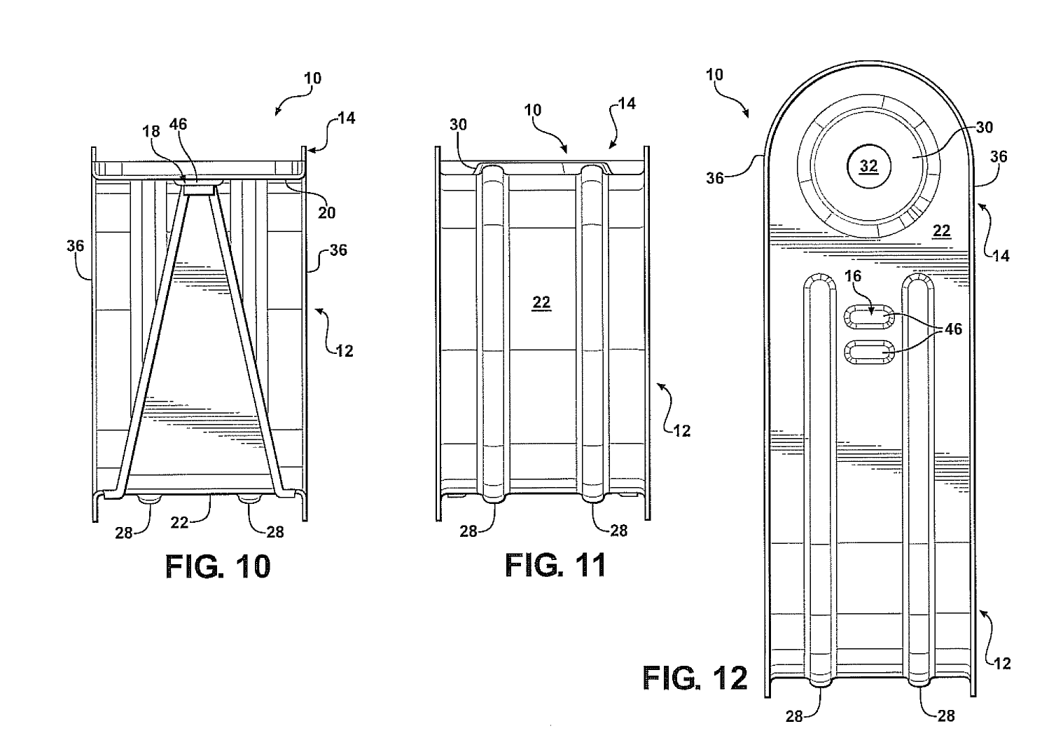

Referring now to FIGS. 1-12, a support 10 for supporting a run of cables, wires or conduit (not shown) and for other uses, may include a semi-circular saddle 12, a stem portion 14, a closing tab 16, and a catch 18. The saddle 12, which may retain and support a plurality of cables, may with the rest of the support 10, include a front 20 face and a rear face 22. The stem 14 and closing tab 16 may be formed integrally with, and extend from, respective ends 24, 26 of the saddle 12. More specifically, the stem 14 of the support 10 may be formed integrally with, and extend tangentially from, one end 24 of the saddle 12 with the catch 16 being supported on or by the stem 14 opposite the closing tab 16. The closing tab 16 may extend from an opposite end 26 of the saddle 12 and be tapered along its length. As shown, the saddle 12 and stem 14 may have a generally uniform width. However, the width of the closing tab 16 where the tab 16 joins the saddle 12 may be smaller than the width of the saddle 12. It will be appreciated that the closing tab 16 may also have a width that is the same as the saddle 12 and stem 14. In operation, the closing tab 16 may be movable between a first orientation in which the tab 16 extends tangentially from the end 26 of the saddle 12 and the saddle 12 is open, a second orientation in which the closing tab 16 engages the catch 18 to form a rigid closure of the saddle 12. Additionally, or alternatively, the tab 16 may be positioned into a third orientation between the first and second orientation.

Still referring to FIGS. 1-12, the support 10 may be constructed using conventional metal shaping techniques applied to a strip of sheet metal (steel). For example, the strip may be a mild carbon steel that is 0.8 mm to 1.7 mm in thickness based on the size of hooks. It will, however, be appreciated that the support 10 may also be constructed using a variety of materials other than or in addition to steel with the particular type of metal, metal alloy, or polymer used being predetermined by the user so that resulting support 10 conforms to the user's needs for strength, insulating properties, electrical interference or the like.

Still referring to FIGS. 1-12, the support 10 may include stiffing ribs 28 that are stamped into the front face 20 of the support 12 and extend from the stem 14 around the saddle 12. Moreover, a recessed portion 30 may be defined in the front face 20 of stem 14 that includes a mounting aperture 32. The mounting aperture 32 may be dimensioned to receive commercially fasteners, brackets and the like (not shown). It will also be appreciated that the use of the recessed portion 30 may permit the head (not shown) of a fastener (not shown) to sit flush with the front face 20 of the stem 14.

Referring now to FIGS. 1-6, a plastic cover 34 may be injection molded or otherwise formed or positioned around the support 10. The cover 34 may, for example, be formed from polypropylene and molded so that it overlays the front face 20 of the saddle 12, the closing tab 18 and at least a portion of the stem 14. The cover 34 may also extend around each edge 36 of the support 10 to overlay the sides 38 (see FIG. 6) of the rear face 22. This arrangement of the cover 34 on the rear face 22 of the support 10 also defines a finger channel 40 that allows for greater easy in handling the support 10 during installation.

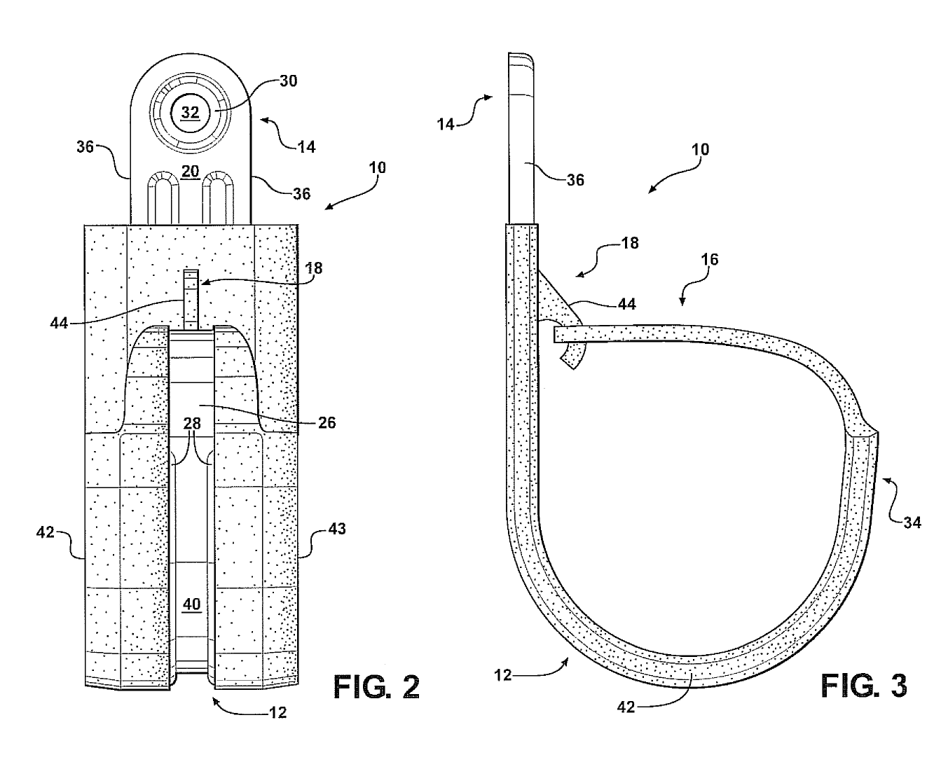

Still referring to FIGS. 1-6, the cover 34 may have a width that is greater than the width of the saddle with each edge 42, 43 of the cover 34 extend radially outwardly from the support 10. However, as shown in FIG. 2, the width of the cover 34 that overlays the closing tab 16 may be smaller at the point where the tab 16 joins the saddle 12 than the width of the cover 34 that overlays the saddle 12. The portion of the cover 34 that overlays the closing tab 16 may also be dimensioned to closely conform to the tapered width of the tab 16.

Still referring to FIGS. 1-6, each edge 42, 43 of the cover 34 may be angled with respect to the portion of the cover 34 that directly overlays the front 20 or rear 22 face of the support 10. For example, as shown in FIGS. 1 and 3, the edges 42 of the cover 34 that overlay the front face 20 may extend downward, forming an obtuse angle. Likewise, as shown in FIGS. 1, 3, and 5, the edge 43 of the cover 34 that overlays the rear face 22 may extend upward, also forming an obtuse angle relative to portion of the cover overlaying the rear face 22. Notably, the use of the obtuse angled edge 42 on the cover 34 overlaying the front face 20 of the saddle 12 may function as a guide for cable (not shown) positioned in the support 10. The cover 32 may also function to provide a smooth surface and transitioning edge to prevent damage from being inflicted on the cable during installation and use.

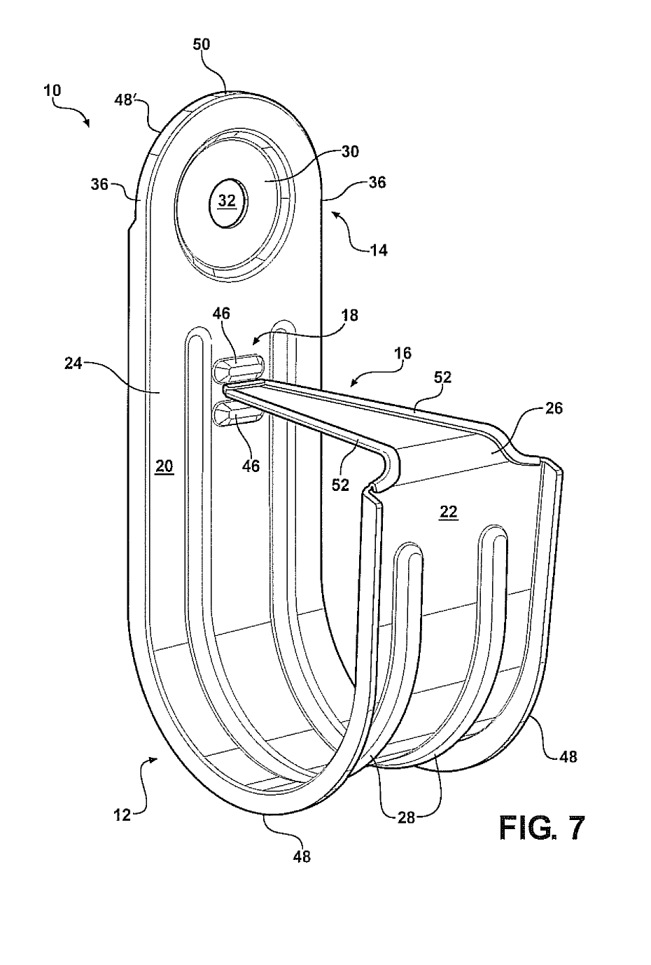

Referring now to FIGS. 1-4, the catch 16 may be formed as a hook 44 that is formed integral with the cover 34. Alternatively, as shown in FIGS. 7-10 and 12, the catch may include of a pair of vertically spaced detents 46 that are stamped or otherwise formed in the stem 14.

As mentioned supra, the support 10 may be strengthened through the use of a pair of stiffing ribs 28 that may extend from the stem 14 around the saddle 16. Alternatively, or additionally, as shown in FIGS. 1-12, and as best shown in FIG. 7-12, each edge 36 of support 10 may be shaped to include are pair of parallel flanges 48 that project downwardly at right angles from respective sides of the support 12 and that also extend from the stem 14 around the saddle 12. The flanges 48, 48′ may also be adapted to extend all the way from the end 50 of the stem 14. Moreover, the edges 32 of the support 10 at the closing tab 16 may likewise include a flange 52 that may be crimped to partially overlay the rear face 22 of tab 16.

Finally, and referring again to FIGS. 1-12, and as mentioned supra the closing tab 16 may be moveable at least in the region where the closing tab 16 extends from the saddle 12 such that the tab 16 may be placed in a first, second or third orientation. As such, it will be appreciated that the support 10 (and the tab 16) may be constructed of materials having the requisite thickness and strength capability to permit the tab 16 to be flexible while still functioning to form a rigid closure to the saddle 12. Additionally, or alternatively, the tab 12 may be secured to the saddle 12 by a hinge assembly, including living hinge.

Having described our invention, other and additional preferred embodiments will become apparent to those skilled in the art to which it pertains, and without deviating from the scope of the appended claims:

We claim:

1. A support comprising:
a semi-circular saddle, a stem portion, a closing tab and a catch, the saddle having a front face and a rear face and being operable to support a plurality of cables, the stem being formed integral with and extending tangentially from one end of the saddle, the closing tab extending from an opposite end of the saddle and being tapered along its length, and the catch being supported on the stem opposite the closing tab, with a width of the closing tab being smaller than a width of the saddle at the point the closing tab extends from the saddle, the closing tab also being movable between a first orientation in which the saddle is open and a second orientation in which the closing tab engages the catch to form a rigid closure of the saddle.

2. The support of claim 1 further comprising a plastic cover, the cover extending over the front face of the saddle including the closing tab and a portion of the stem, and wherein the catch includes a hook formed in the cover.

3. The support of claim 2 wherein the plastic cover extends around each edge of the saddle to overlay a portion of each side of the rear face of the saddle including the stem and closing tab to define a finger channel for use in holding the support during installation.

4. The support of claim 3 wherein the plastic cover comprises angled edge portions with the edge portion of the front face forming an obtuse angle relative to the front face and the edge portion of the rear face forming an obtuse angle relative to rear face.

5. The support of claim 4 wherein the saddle further comprises a pair of stiffing ribs.

6. The support of claim 5 wherein the stem comprises a recessed portion defined in the front face.

7. The support of claim 6 wherein the recessed portion of the stem defines a mounting aperture.

8. The support of claim 7 wherein the end of the closing tab remote from the opposite end of the saddle defines a catch aperture operable the receive the hook and retain the tab in the second orientation.

9. The support of claim 1 wherein the catch comprises a pair of vertically spaced apart detents formed in the stem.

10. The support of claim 9 further comprising a stiffening flange extending from the stem and around the saddle, the flange projecting downwardly at right angles relative to the front face from respective sides of the support.

11. The support of claim 10 wherein the saddle further comprises a pair of stiffing ribs.

12. The support of claim 11 wherein the close tab further comprising a stiffening edge.

13. The support of claim 12 wherein the stiffening edge comprises a crimped edge portion overlaying the rear face of the closing tab.

14. The support of claim 13 wherein the stem comprises a recessed portion defined in the front face.

15. The support of claim 14 wherein the recessed portion of the stem defines a mounting aperture.

16. The support of claim 1, wherein the closing tab is connected to the saddle by a hinge.

17. The support of claim 16 wherein the hinge comprises a living hinge.

18. The support of claim 1, wherein the closing tab is positioned at a third intermediate orientation between the first orientation and the second orientation.

19. A support comprising: a semi-circular saddle, a stem portion, a closing tab and a catch, the saddle having a front face and a rear face and being operable to support a plurality of cables, the stem being formed integral with and extending tangentially from one end of the saddle, the closing tab extending from an opposite end of the saddle and being tapered along its length, and the catch being supported on the stem opposite the closing tab, the closing tab also being movable between a first orientation in which the saddle is open and a second orientation in which the closing tab engages the catch to form a rigid closure of the saddle; and
a plastic cover extending over the front face of the saddle, including the closing tab and a portion of the stem and around each edge of the saddle to overlay a portion of each side of the rear face of the saddle including the stem and closing tab to define a finger channel for use in holding the support during installation, the width of the cover that overlays the closing tab being smaller at the point where the tab joins the saddle than the width of the cover that overlays the saddle.

20. The support of claim 19 further comprising a stiffening flange and a pair of stiffing ribs.
